(19) United States
(12) Patent Application Publication
(10) Pub. No.: US 2012/0314280 A1
(43) Pub. Date: Dec. 13, 2012

(54) OPTICAL COMPONENT FOR PROTECTION AGAINST THERMAL RADIATION

(76) Inventors: Michel Luttmann, Belin Beliet (FR); Gael Paquignon, Le Barp (FR)

(21) Appl. No.: 13/579,947

(22) PCT Filed: Feb. 17, 2011
(86) PCT No.: PCT/FR2011/050339

§ 371 Date: Aug. 20, 2012

(30) Foreign Application Priority Data
Feb. 19, 2010 (FR) 1051221

(51) Int. Cl. G02B 5/28; G02B 13/14

(52) U.S. Cl. 359/356; 359/359

(57) ABSTRACT

An optical component (6) for a heat screen to be placed between a cold medium and a hot medium, includes a substrate (7) having a first face to be disposed facing towards the cold medium and a second face to be disposed facing towards the hot medium, the substrate being formed from a material that is transparent to optical radiation in the visible and/or near infrared wavelength region and the material having a crystalline or polycrystalline structure. The optical component (6) further includes a thin layer (8) deposited on the second face of the substrate (7), the thin layer (8) being electrically conductive, transparent to visible and/or near infrared optical radiation and reflective to mid and far infrared thermal radiation.

The present invention relates in general to an optical component for a heat screen, said optical component allowing optical radiation to pass through while ensuring effective protection against thermal radiation. More precisely, the invention relates to an optical component that can transmit a light beam without introducing either optical aberrations or disturbances and providing good insulation against thermal radiation while heating up very little.

In the present document, the term “window” means a transparent optical component and the term “port” means the assembly formed by a window and its mount for mechanical attachment to the frame of a heat screen. We are essentially concerned with the window of a port of a heat screen.

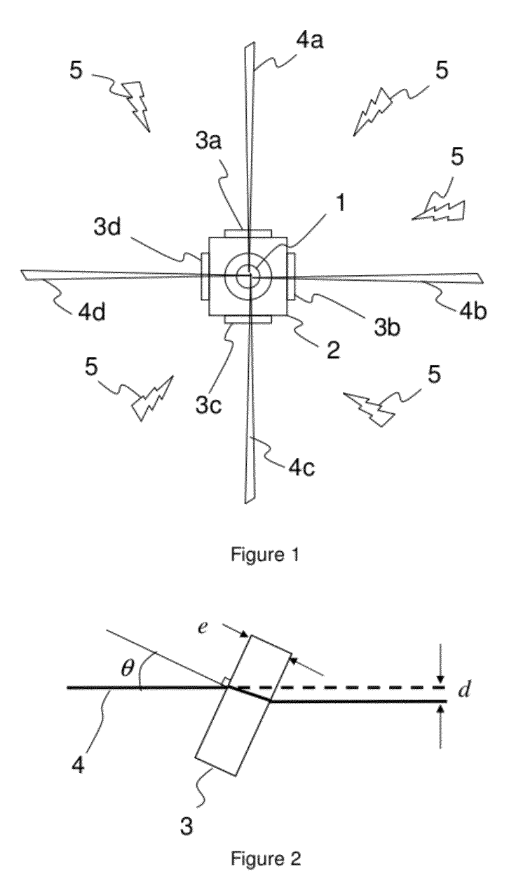

A heat screen provided with windows can be used to reduce heat exchange between two media while allowing inspection via viewing means. In particular, a heat screen is used when optically aligning a cryogenic sample intended to act as a target for a set of laser beams in an experiment observing laser-matter interactions. FIG. 1 diagrammatically shows a cryogenic device comprising a target (1) surrounded by a heat screen (2) provided with windows (3a, 3b, 3c, 3d). The target (1) is cooled to a cryogenic temperature by cooling means, not shown. In one example, the target is cooled by a target holder at a temperature that is maintained at 17 K (kelvin). The device is placed in a vacuum chamber and is exposed to one or more sources (5) of thermal radiation, for example ambient radiation, at a temperature of approximately 300 K.

Alignment of the target (1) relative to the point at which the laser beams converge requires micrometric precision in positioning. A system for viewing in the visible region can be used to carry out optical alignment of the target before firing the laser beam at the target. During the alignment stage, the temperature of the cryogenic target must be stabilized to a few milli-kelvins to prevent any deterioration of the target. Since the target (1) is placed in a vacuum chamber, heat exchange by convection is non-existent. However, the target (1) is capable of receiving thermal radiation deriving from the surroundings of the vacuum chamber at a temperature of approximately 300 K. During optical alignment, the target is thus placed inside a heat screen (2) that can limit the ambient thermal radiation supplied to the target. In the example under consideration, the temperature of the heat screen is kept in the range 17 K to 50 K. The heat screen is provided with ports to allow the viewing system to view the sample during alignment. When the optical alignment is complete, the heat screen (2) is withdrawn so that the laser can be fired directly onto the target.

The windows (3a, 3b, 3c, 3d) of the heat screen, which are present during alignment and absent when the laser is being fired, must therefore not only be transparent to optical radiation, but also must ideally not induce either movement of the beam nor optical aberration in the path of the light beams. Moreover, the windows (3a, 3b, 3c, 3d) help to protect the target from the surrounding 300 K radiation (5).

In practice, the windows (3a, 3b, 3c, 3d) nevertheless disturb the optical alignment of the beams (4a, 4b, 4c, 4d) on the target (1). FIG. 2 diagrammatically represents a sectional view through a window (3), in this example a plate with flat, parallel faces of thickness e, through which a light beam (4) passes forming an angle of incidence θ with one of the faces of the plate. Due to refraction, a light beam is deflected axially by a shift d as it passes through the inclined plate, the shift d being a function of the optical thickness passed through and the angle of incidence. Even for a small angle of incidence θ, inserting or removing a window may result in a shift of the optical axis of the beam. The disturbance induced by the ports increases with increased thickness and/or increased refractive index of the windows of the port. Thus, in a particular experiment, the alignment tolerance on the target is less than 15 μm [micrometer] rms [root mean square], which results in a maximum disturbance due to the ports of 3 μm rms. The same optical alignment is then sought to better than three micrometers, both with and without windows.

The windows also have to limit, as far as possible, the passage of thermal radiation while being transparent in the visible or near infrared region.

Heat screens with glass windows are known that are single or double glazed. However, glass with a thickness of more than 1 mm [millimeter] causes a beam deflection that is more than the alignment constraints indicated above. Clearly, very thin glass exists with a thickness of less than one millimeter, but it has been observed that a glass window subjected to continuous radiation at 300 K ends up being heated up at its center beyond the tolerable limits. In addition, the glass is both transparent and absorbent in the infrared, and so a glass window is not suitable as protection against thermal radiation. Double glazed type windows are also not suitable, since they deflect the light beams even more than single glazing and also absorb infrared radiation.

Indium tin oxide (ITO) treated glass windows also exist that limit transmission of an infrared signal through the window and that limit the absorption of thermal radiation; however, the residual absorption results in an increase in the temperature at the center of the port and produces an excessive temperature gradient from the center towards the edges.

In cryogenic devices, ports comprising a sapphire (Al₂O₃) window 1 mm to 2 mm thick are generally used in which one face may be coated with a treatment that is anti-reflective for visible light. The sapphire material can both filter infrared radiation with wavelengths of more than 5 μm to 6 μm and also conduct heat, which means that heat can be evacuated by conduction via the walls of the heat screen, thus preventing the port from heating up. However, for a 2 mm thick sapphire window, it is necessary to align the ports to better than a few milliradians, which is extremely constraining.

In order to minimize the disturbances (beam deflection, optical aberrations) induced on the optical alignment by the ports, one approach consists in using ports that are as thin as possible. In order to obtain an alignment precision of 3 μm, the thickness of a sapphire window must be reduced to approximately 500 μm. However, such a reduction in thickness degrades the performance of the heat screen. In fact, a 500 μm thick sapphire window transmits 5% of ambient thermal radiation at 300 K and absorbs 45% thereof. The transmitted radiation and the absorbed radiation constitute a non-negligible thermal load on the cryogenic target holder and on the heat screen. Such a thermal load can endanger the conformation of the target, which receives more than 5% of ambient thermal radiation.

A first alternative consists in using a port window formed from a good conductor of heat but with refractive index and/or thickness below that of sapphire, for example a window formed from crystalline MgF₂ (refractive index n=1.38) with a thickness of 500 μm. Such a window can reduce certain optical disturbances that have an impact on the alignment of the target by a factor of six compared with a 2 mm thick sapphire window (the refractive index of sapphire is equal to 1.77). However, MgF₂ transmits infrared radiation up to 10 μm; this transmission is greater for a thinner port. The residual ambient infrared radiation transmission of a thin window may represent 5% to 22% of the thermal radiation received by the window (respectively 5% for an Al₂O₃ window and 22% for an MgF₂ window), which represents a considerable thermal load at the cryogenic target.

The heat screening properties of materials are generally better with increasing thickness, and so it would appear to be difficult, a priori, to find a window for a heat screen that provides effective protection against thermal radiation and that presents small optical thickness so as not to disturb the optical alignment.

The aim of the present invention is to overcome those disadvantages and to propose an optical component for a heat screen that is simultaneously reflective to infrared radiation, a good conductor of heat, and transparent in the visible and/or near infrared region.

More particularly, the present invention provides an optical component for a heat screen to be placed between a cold medium and a hot medium, said optical component being reflective to mid and far infrared radiation, a good conductor of heat, and transparent to visible and/or near infrared optical radiation, said optical component comprising:
a substrate having a first face to be disposed facing towards the cold medium and a second face to be disposed facing towards the hot medium, said substrate being formed from a material that is transparent to optical radiation in the visible and/or near infrared wavelength region and said material having a crystalline or polycrystalline structure so as to have good thermal conductivity; and
a thin layer deposited on said second face of the substrate, said thin layer being electrically conductive and said thin layer being transparent to visible and/or near infrared optical radiation and reflective to mid and far infrared thermal radiation.

In accordance with various aspects of particular embodiments of the invention:
the material of the substrate is selected from the following materials: MgF₂, crystalline silica (or quartz), Al₂O₂, crystalline or polycrystalline silicon, CaF₂ and ZnSe;
the thermal conductivity of the substrate is in the range 5 Wm⁻¹K⁻¹ [watt per meter-kelvin] to 6000 Wm⁻¹K⁻¹;
the thin conductive layer comprises a layer of indium and tin oxide (ITO) or a layer of zinc oxide (ZnO) or a layer of aluminum-doped zinc oxide (AZO) or a layer of tin oxide (SnO₂);
the thickness of the thin conductive layer is in the range 100 nm [nanometers] to 1 μm;
said first face includes a treatment that is anti-reflective to optical radiation in the visible and/or near infrared wavelength region so as to increase the transmission coefficient of the component in the visible and/or near infrared region;
said optical component has a mean transmission coefficient of more than 70% and/or a transmission peak of more than 90% in the visible and/or near infrared region;
said optical component has a mean reflection coefficient of more than 80% in the mid and far infrared region;
the component is less than 2 mm thick;
said optical component is selected from the following components: a plate with flat, parallel faces, a prism, a lens, a microlens array and a lens prism.

The invention also provides a heat screen comprising an optical component in accordance with any one of the embodiments described.

The invention is of particularly advantageous application in a heat screen window for a cryogenic target.

The present invention also provides characteristics that become apparent from the following description and that should be considered in isolation or in any of their technically feasible combinations.

This description, given by way of non-limiting example, provides a better understanding of how the invention can be implemented and is made with reference to the accompanying drawings in which:

FIG. 1 is a diagrammatic representation of a cryogenic target and a heat screen exposed to optical and thermal radiation;

FIG. 2 is a diagrammatic representation of a sectional view of a plate with flat, parallel faces and the deflection of a light beam as it passes through the plate;

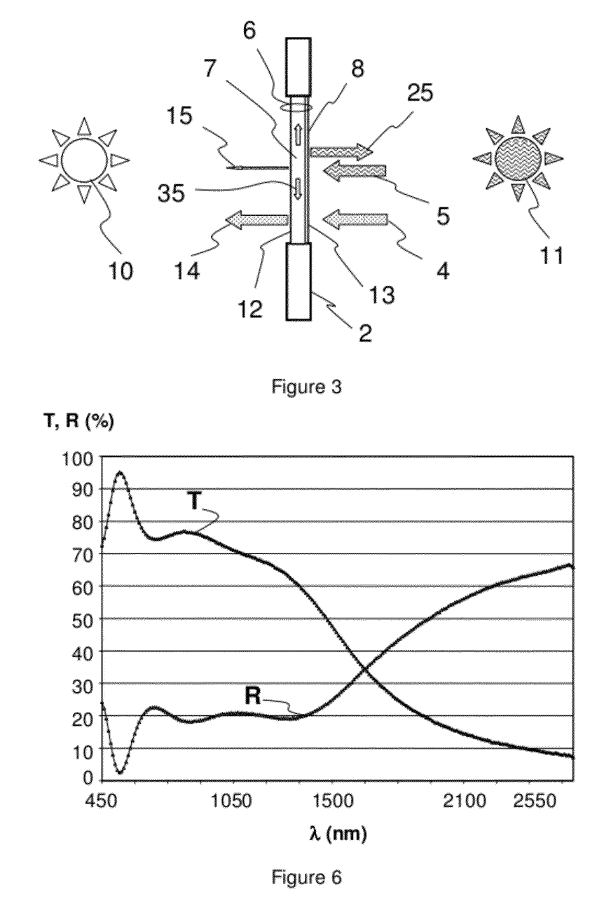

FIG. 3 represents a sectional view of a heat screen window placed between a cold medium and a hot medium and diagrammatically represents the various exchanges of thermal and optical radiation through the window;

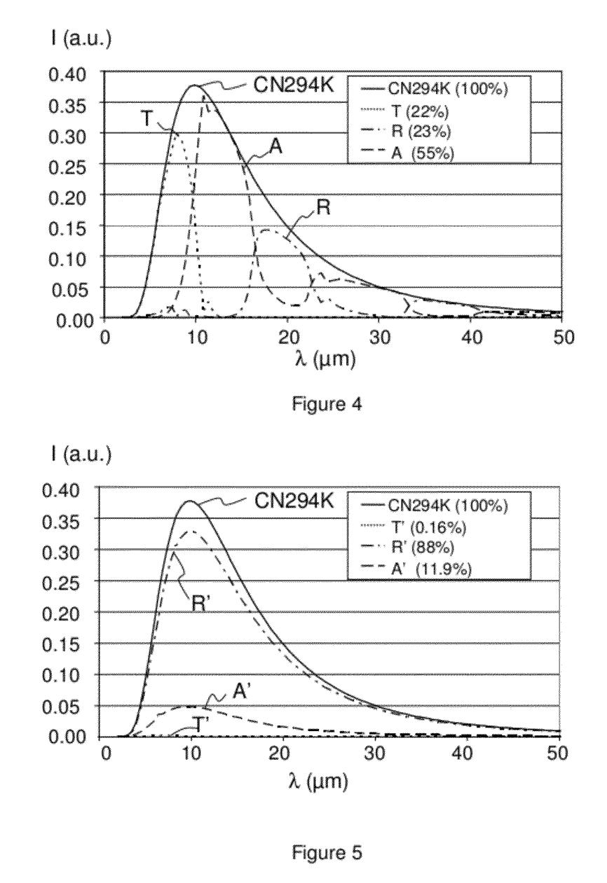

FIG. 4 represents the black body spectrum at 294 K and the transmission, reflection, and absorption curves of a thin MgF₂ window relative to black body radiation over the spectral region extending from the mid infrared to the far infrared;

FIG. 5 represents the black body spectrum at 294 K and the transmission, reflection, and absorption curves relative to black body radiation of a window in accordance with one embodiment of the invention over the spectral region extending from the mid infrared to the far infrared; and

FIG. 6 represents the transmission and optical reflection curves in the visible-near infrared region for a window in accordance with one embodiment of the invention.

The present document uses the following terms:
“visible optical radiation” is electromagnetic radiation, which may optionally be monochromatic, with a wavelength in the range 380 nm to 780 nm;
“near infrared radiation” (NIR) is radiation with a wavelength in the range 780 nm to 1.6 μm;
“mid infrared radiation” is radiation with a wavelength in the range 2.5 μm to 25 μm;
“far infrared radiation” is radiation with a wavelength in the range 25 μm to 1 mm;
“material or component that is reflective over a specific spectral region” is a material or component for which the mean reflection coefficient over the spectral region under consideration is more than 80%;
“material or component that is transparent over a specific spectral region” is a material or component for which the mean coefficient of transmission over the spectral region under consideration is more than 70% and/or that has a transmission peak of more than 90% over the spectral region under consideration; and
“cutoff wavelength λc of a material” is a wavelength separating the region with a small imaginary portion of the complex refractive index of the material (generally in the visible or near infrared) from the region in which the imaginary portion of its complex refractive index increases greatly with wavelength.

The thermal radiation is essentially constituted by mid and/or far infrared radiation.

FIG. 3 diagrammatically shows a sectional view of a portion of heat screen (2) mounted between a cold source (10) and a hot source (11). The cold source (10) may, for example, represent a sample at a cryogenic temperature. The hot source (11) may, for example, derive from ambient thermal radiation. The heat screen (2) comprises a window (6) for passing a light beam (4) and is at a temperature intermediate between the hot source and the cold source.

FIG. 3 represents the various exchanges of optical and thermal radiation by arrows with respective thicknesses that provide an indication of their relative intensities. Thus, the arrow (4) represents optical radiation incident on the window (6) and the arrow (14) represents the optical radiation transmitted by the window (6). The optical radiation (4, 14) may include wavelengths in the visible and/or near infrared region. The arrow (5) represents infrared thermal radiation (mid and/or far) incident on the window (6), the arrow (15) represents the mid and/or far infrared radiation transmitted by the window (6) and the arrow (25) represents the mid and/or far infrared radiation reflected by the window (6). Emission arrows for the window, linked to its temperature, are not shown. The arrow (35) represents the mid and/or far infrared radiation absorbed by the window and transmitted in the direction of the walls of the heat screen (2) by thermal conduction.

A conventional window for an heat screen in a cryogenic device is constituted by a plate with a thickness of 2 mm to 5 mm with flat, parallel faces that may optionally be given an anti-reflective treatment to improve transmission in the visible.

FIG. 4 diagrammatically represents the transmission (T, dotted line), absorption (A, dashed line), and reflection (R, dot-dash line) curves for an MgF₂ window with a thickness reduced to 500 μm in the mid and/or far infrared region compared with the thermal radiation spectrum (curve CN294K, solid line) of a black body at a temperature of 294 K.

One of the facts forming part of the invention is that overall, the thin MgF₂ window transmits 22%, reflects 23% and absorbs 55% of the thermal radiation of a black body at 294 K, the calculation being integrated over the spectral region from 2.5 μm to 100 μm. In more detail, it is observed on FIG. 4 that the MgF₂ window transmits the largest portion of thermal radiation over the wavelength region in the range from approximately 2 μm to 10 μm. The MgF₂ window absorbs the major portion of the thermal radiation in the spectral region from 10 μm to 15 μm and from 22 μm to −35 μm. Finally, the MgF₂ window reflects thermal radiation over wavelength regions from 15 μm to 22 μm and from 35 μm to 40 μm. The thermal radiation absorbed by the MgF₂ window may be evacuated by conduction towards the walls of the heat screen.

This means that a thin MgF₂ window transmits (22%) and absorbs (55%) the majority of the infrared signal, meaning that the performance of the heat screen is degraded.

There follows a detailed description of an optical component in accordance with one embodiment of the invention.

More particularly, this optical component is intended for a heat screen for the cryogenic chamber of a megajoule laser target.

The optical component (6) is formed by a crystalline or polycrystalline substrate (7) (formed from MgF₂, quartz or sapphire, etc.) with one face (13) coated in an electrically conductive layer (8) having properties and a thickness that are selected so as to transmit visible and/or near infrared radiation and to reflect mid and far infrared radiation, the layer (8) being disposed on the hot source (11) side.

Preferably, a substrate (7) is used that is transparent in the visible region and a layer (8) that is also transparent in the visible wavelength region, which means that a light beam can be used for alignment or viewing in the visible.

In another particular embodiment, a substrate (7) is used that is transparent in the near infrared wavelength region, such as a crystalline silicon, for example, which is not transparent in the visible. Hence, a layer (8) is used that is also transparent in the near infrared wavelength region above the wavelength corresponding to the crystalline silicon gap, which means that an optical alignment or visualization beam can be used in the near infrared region.

In accordance with a preferred embodiment, the optical component (6) is a plate having two flat, parallel faces (12, 13), the substrate (7) is an MgF₂ crystal, with one face (13) coated in a layer of indium tin oxide (ITO), the ITO layer being approximately 240 nm thick. The face (13) coated with an ITO layer is intended to be placed on the hot side, i.e. towards the outside of the heat screen; the other face (12) of the substrate is directed towards the cryogenic target.

In a particular embodiment, the second face (12) of the optical component (6) is coated with a layer that is anti-reflective in the visible region (target side).

FIG. 5 represents respectively the transmission (T′, dotted line), absorption (A′, dashed line) and reflection (R′ dot-dash line) curves in the infrared relative to the spectrum (curve CN294K, solid line), of a black body with a temperature of 294 K, for a 0.5 mm thick window (6) of MgF₂ with one face coated in a 240 nm thick layer (8) of ITO.

Firstly, it should be observed in FIG. 5 that the window (6) of the invention has an infrared transmission T′ integrated over the 2.5 μm to 100 μm region of 0.16% compared with the black body spectrum, i.e. a hundred times less than the infrared transmission curve of FIG. 4, for an MgF₂ window without ITO treatment.

It can also be observed in FIG. 5 that the major portion (88%) of the infrared radiation is reflected over the whole mid and far infrared region (from −3 μm to 50 μm). A relatively small portion (11.9%) of the thermal radiation is absorbed by the optical component (6) on the black body spectrum. In total, the infrared radiation absorbed by the optical component (6) is reduced by a factor of 5 compared with the simple MgF₂ window (cf. FIGS. 4 and 5).

Even if a portion of the thermal radiation is absorbed by the optical component (6), the thermal conductivity of the crystalline MgF₂ substrate (7) means that the heat absorbed can be evacuated by conduction towards the walls of the heat screen. The crystalline or polycrystalline substrate (7) has excellent thermal conductivity (generally 10 to 1000 times higher than that of an amorphous material such as glass), which means that the heat load caused by residual absorption of 300 K radiation can be rapidly evacuated, thereby preventing the window from heating up. Depending on the type of crystalline or polycrystalline material selected for the substrate (7) and on the temperature, the thermal conductivity of the substrate is in the range 5 Wm⁻¹K⁻¹ to 6000 Wm⁻¹K⁻¹.

In the embodiment described in detail above, the thickness of the substrate is 500 μm. The good conductance of the substrate (product of the conductivity and the thickness of the substrate) means that the temperature gradient between the center and the edges of the window can be reduced to less than 5 K.

The ITO-treated MgF₂ window (6) can thus be used to simultaneously and substantially reduce the transmitted and absorbed thermal radiation. Firstly, the thermal radiation transmitted through the window (6) is reduced by a factor of 100, which means that the thermal load that might reach the cryogenic target can be reduced in as much. In contrast, the thermal radiation absorbed by the window (6) is reduced by a factor of 5 compared with the same window without ITO treatment.

Thus, the presence of a window of the invention does not disturb the function of the heat screen, namely to protect the target (1) from ambient thermal radiation. An optical component termed a “cold port” is obtained, which is an efficient protector against heat. The port remains cold since it reflects infrared radiation better than an MgF₂ window and is a good conductor of absorbed residual heat towards the support (2).

FIG. 6 shows the optical transmission and reflection curves in the visible and near infrared region of the ITO-treated MgF₂ window described in connection with FIG. 5. It should be observed that the optical transmission curve is at a maximum ((95%) at a visible wavelength of 532 nm. The thickness of the ITO layer has been selected such that the position of this peak coincides with the wavelength of the alignment laser of the target. The MgF₂ window reflects a portion of the visible radiation (less than 20%) and more strongly reflects near infrared radiation (20% to 65% of the 760 nm to 2550 nm band).

The material of the substrate is advantageously a material with a low refractive index in the visible so as to reduce the disturbances on the optical alignment beams and to maximize transmission at 532 nm.

The optical component (6) of the invention thus offers advantages of having strong reflection and low absorption as regards thermal radiation, while allowing the optical target alignment beam at 532 nm to pass through with a minimum of disturbances.

As indicated above, the electrically conductive layer (8) is placed facing the hot source (15), for example exposed to an ambient temperature of ˜300 K. The thickness of the conductive layer (8) and its properties may be selected so as to optimize transmission in the visible or near infrared and to maximize the reflection in the mid and far infrared. Thus, to reduce the IR signal transmitted by the window and to increase the reflected IR signal, the thickness of the ITO layer must be increased. In contrast, in order to maximize the overall transmission in the visible, the thickness of the ITO layer must be reduced. Another route to optimizing transmission at a particular wavelength in the visible (for example 532 nm) is to select the thickness of the ITO layer so as to produce an anti-reflective layer at the wavelength in question.

By optimizing the thickness (≈=240 nm) and the stoichiometry (for example 92.5% In₂O₃ and 7.5% SnO₂ for the above-mentioned example) of the ITO layer, the layer (8) having a surface electrical conductivity of the order of 10Ω/□, a window may be obtained with transmission at 532 nm of more than 90%, an infrared reflection of more than 85% and a near-zero transmission in the infrared. The window of the invention can thus simultaneously block transmission of the mid and far infrared signal by very effectively reflecting the infrared radiation and limiting the absorption of the infrared signal by the substrate, which limits heating of the window.

In a particular embodiment, the window also comprises an anti-reflective treatment in the visible deposited on the face (12) of the port disposed on the cryogenic target side in order to further optimize transmission in the visible.

The invention is not limited to the embodiments described above. It is possible to select various combinations of types of material and thicknesses that are suitable for the crystalline substrate and for the conductive layer as a function of the wavelength of the visible or near infrared light beams.

As an example, the material of the substrate (7) may be selected from the following materials: MgF₂, CaF₂, ZnSe, quartz (or crystalline silica), crystalline or polycrystalline silicon, and Al₂O₃, and the material of the conductive layer (8) may be selected from ITO, ZnO, AZO (aluminum-doped zinc oxide), or SnO₂, doped or otherwise.

In the preferred embodiment, the optical component (6) is a plate with flat, parallel faces. However, the invention is not limited to this embodiment.

In other embodiments, the optical component may, for example, be a lens manufactured from a crystalline material one face of which, intended to be exposed to the hot medium, is coated with a conductive layer (8). The optical component (6) may, for example, be a plane-convex lens one face of which is coated with an electrically conductive layer (8) of the invention. In accordance with another embodiment, the optical component (6) is a microlens array. In another embodiment, the optical component (6) is a prism, or a lens prism.

In conclusion, the window of the invention transmits a minimum of thermal radiation and reflects a maximum of ambient thermal radiation, which means that the thermal load deposited on the heat screen can be reduced, with a gain of the order of a factor of five compared with a conventional window. Further, the window of the invention is cut into a crystal with good thermal conductivity, and so it can be maintained at a very low temperature (less than 50 K in our application) while remaining very thin.

In addition, the window of the invention has a high transmission at the wavelength of the laser alignment beams (transmission of more than 90% at 532 nm) and results in an alignment error of less than a few micrometers.

In the preferred application, the alignment is carried out at 532 nm, i.e., in the visible region. However, the same ports may also be used during a phase for optical characterization of the target based on the use of visible radiation at 532 nm and near IR radiation at 1330 nm. However, a lower transmission of the port in the near IR can be tolerated.

The invention can be used to obtain a cold port that is transparent to visible optical radiation, which induces limited optical disturbances (beam movement, optical aberrations) and that remains cold since it reflects infrared radiation and conducts absorbed residual heat well.

The invention can be used to obtain a cold port that is thin and has excellent performance as a heat screen. A window of the invention can even offer better thermal protection than that of a conventional, thicker, window. Further, the window of the invention is lighter than a conventional window.

1. An optical component (6) for a heat screen (2) to be placed between a cold medium (10) and a hot medium (11), said optical component (6) being reflective to mid and far infrared radiation, a good conductor of heat, and transparent to visible and/or near infrared optical radiation (4, 4a, 4b, 4c, 4d), said optical component (6) comprising:
a substrate (7) having a first face (12) to be disposed facing towards the cold medium (10) and a second face (13) to be disposed facing towards the hot medium (11), said substrate being formed from a material that is transparent to optical radiation (4, 4a, 4b, 4c, 4d) in the visible and/or near infrared wavelength region and said material having a crystalline or polycrystalline structure so as to have good thermal conductivity; and
a thin layer (8) deposited on said second face (13) of the substrate (7), said thin layer (8) being electrically conductive and said thin layer (8) being transparent to visible and/or near infrared optical radiation (4, 4a, 4b, 4c, 4d) and reflective to mid and far infrared thermal radiation.

2. An optical component (6) according to claim 1, characterized in that the thermal conductivity of the substrate (7) is in the range 5 Wm⁻¹K⁻¹ to 6000 Wm⁻¹K⁻¹.

3. An optical component according to claim 1, characterized in that the material of the substrate (7) is selected from the following materials: MgF₂, crystalline silica, Al₂O₂, crystalline or polycrystalline silicon, CaF₂ and ZnSe.

4. An optical component (6) according to claim 1, characterized in that the thin conductive layer (8) comprises a layer of indium and tin oxide (ITO), a layer of zinc oxide (ZnO), a layer of aluminum-doped zinc oxide (AZO) or a layer of tin oxide (SnO₂).

5. An optical component (6) according to claim 1, characterized in that the thickness of the thin conductive layer (8) is in the range 100 nm to 1 μm.

6. An optical component (6) according to claim 1, characterized in that said first face (12) comprises a treatment that is anti-reflective to optical radiation in the visible and/or near infrared wavelength region so as to increase the transmission coefficient of the component in the visible and/or near infrared region.

7. An optical component (6) according to claim 1, characterized in that said optical component has a mean transmission coefficient of more than 70% and/or a transmission peak of more than 90% in the visible and/or near infrared region.

8. An optical component (6) according to claim 1, characterized in that said optical component has a mean reflection coefficient of more than 80% in the mid and far infrared region.

9. An optical component (6) according to claim 1, characterized in that the component (6) is less than 2 mm thick.

10. An optical component (6) according to claim 1, characterized in that said optical component is selected from the following components: a plate with flat, parallel faces, a prism, a lens, a microlens array and a lens prism.

11. A heat screen comprising an optical component (6) according to claim 1.

12. An optical component according to claim 2, characterized in that the material of the substrate (7) is selected from the following materials: MgF₂, crystalline silica, Al₂O₃, crystalline or polycrystalline silicon, CaF₂ and ZnSe.
